(19) United States
(12) Patent Application Publication
(10) Pub. No.: US 2013/0033415 A1
(43) Pub. Date: Feb. 7, 2013

(54) DISPLAY SYSTEM USING AT LEAST TWO SIMILAR DISPLAY DEVICES AND METHOD THEREOF

(71) Applicants: TING-SHE CHANG, Tu-Cheng (TW); TSUNG-JEN CHUANG, Tu-Cheng (TW); SHIH-FANG WONG, Tu-Cheng (TW)

(72) Inventors: TING-SHE CHANG, Tu-Cheng (TW); TSUNG-JEN CHUANG, Tu-Cheng (TW); SHIH-FANG WONG, Tu-Cheng (TW)

(73) Assignee: HON HAI PRECISION INDUSTRY CO., LTD., Tu-Cheng (TW)

(21) Appl. No.: 13/330,687

(22) Filed: Dec. 20, 2011

(30) Foreign Application Priority Data
Aug. 1, 2011 (CN) 201110217741.1

(51) Int. Cl. G09G 5/00

(52) U.S. Cl. 345/1.3

(57) ABSTRACT

A display system includes a primary display device and a secondary display device. The display system further comprises a first detecting unit, a storage unit, and a processor. The first detecting unit is configured for detecting if the secondary display device is adjacent to the primary display device. The first detecting unit generates a detecting signal in the condition that the secondary display device is detected to be adjacent to the primary display device. The storage unit configured for storing a picture. The processor receives the detecting signal, divides the picture into a primary part and a secondary part according to the detecting signal. The processor controls the primary display device to display the primary part of the picture and controls the secondary display device to display the secondary part of the picture. A method of dividing and displaying a picture using the display system is also provided.

### BACKGROUND

1. Technical Field

The present disclosure relates to display systems, and more particularly, to a display system using at least two similar display devices and a method thereof.

2. Description of Related Art

Displays are widely used in all kinds of our lives and users always want to observe a picture of image on a larger screen. However, a display device can only display a picture with its limited display screen. That is, for example, even when a user owns two similar displays, such as two televisions, the two televisions can not work together to display an enlarged picture of an image.

Therefore, a display system is desired to overcome the above-described shortcomings.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic view of a display system according to one embodiment of the present disclosure, the display system including a primary display device and at least one secondary display device.

FIG. 2 is a schematic, block diagram of one embodiment of the primary display device of FIG. 1, the primary display device including a detecting unit.

FIG. 3 is a schematic, block diagram of one embodiment of the detecting unit of FIG. 2.

FIG. 4 is a schematic view of the distance detecting unit having four distance detectors arranged at four sides of the primary display device of FIG. 1.

FIG. 5 is a flowchart of a method for dividing and displaying a picture using the display system.

FIG. 6 is a flowchart showing the method of FIG. 5 to divide the picture into a primary part and a secondary part.

FIG. 7 is a flowchart of a detecting process of the method of FIG. 5 according to one embodiment of the present disclosure.

### DETAILED DESCRIPTION

Reference will now be made to the drawings to describe various inventive embodiments of the present disclosure in detail, wherein like numerals refer to like units throughout.

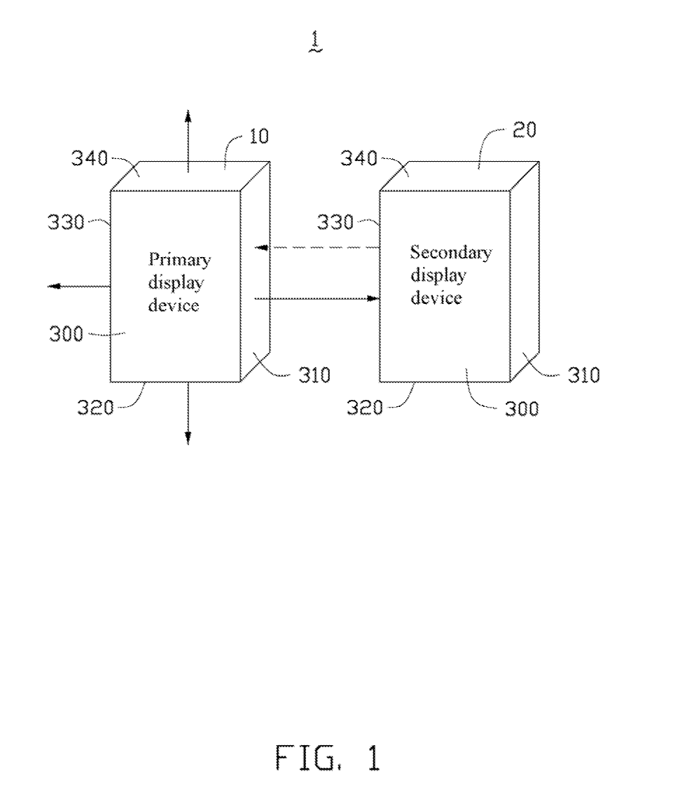

FIG. 1 is a schematic view of a display system 1 according to one embodiment of the present disclosure, the display system 1 including a primary display device 10 and at least one secondary display device 20 (only one shown). The secondary display device 20 is adjacent to the primary display device 10. The primary display device 10 and the secondary display device 20 have a same configuration or functions and are described in detail using the primary display device 10 for example. In this embodiment, the primary display device 10 and the secondary display device 20 are mobile phones and can transmit information therebetween by conductive wires or wireless communication, such as via BLUETOOTH or infrared communication. In an alternative embodiment, the primary display device 10 and the secondary display device 20 may be televisions or portable computers.

The primary display device 10 includes a rectangular display surface 300, a first side 310, a second side 320, a third side 330 opposite to the first side 310, and a fourth side 340 opposite to the second side 320. The display surface 300 is configured for displaying an image or picture. The first to fourth sides 310-340 are adjacent to four edges of the display surface 300 and are connected from beginning to end to surround the display surface 300.

In this embodiment, the first and the third sides 310, 330 are longer than the second and the fourth sides 320, 340, respectively. The secondary display device 20 is adjacent to the primary display device 10, and the third side 330 of the secondary display device 20 faces the first side 310 of the primary display device 10.

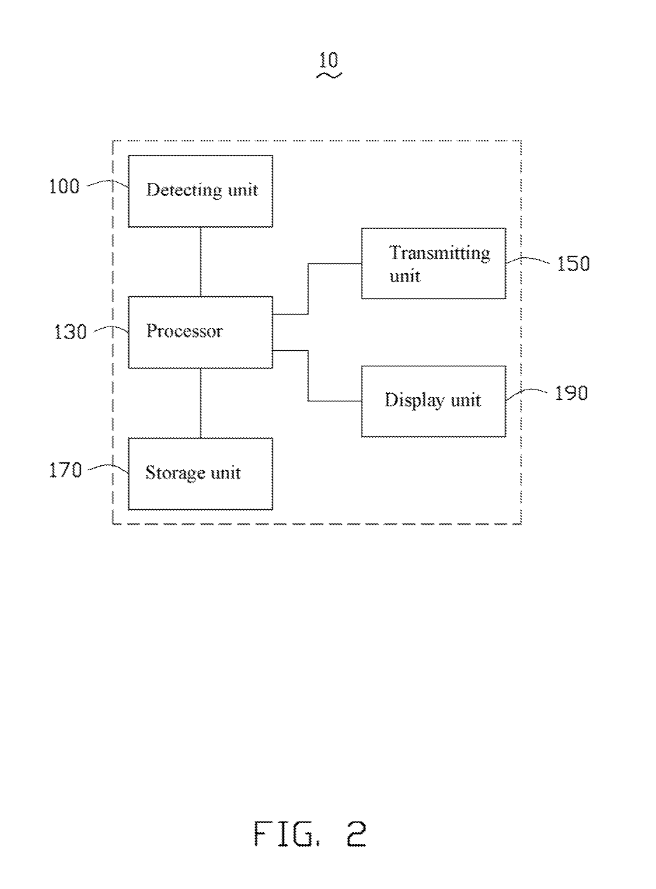

FIG. 2 is a schematic, block diagram of one embodiment of the primary electrical 10 device of FIG. 1, the primary display device 10 including a detecting unit 100. The primary display device 10 further includes a processor 130, a transmitting unit 150, a storage unit 170, and a display unit 190 having the display surface 300.

The detecting unit 100 of the primary display device 10 is configured for detecting the at least one secondary display device 20 to confirm both the number of the at least one secondary display device 20 and a position of each secondary display device 20 relative to the primary display device 10. Operations of the detecting unit 100 are detailed described as followings.

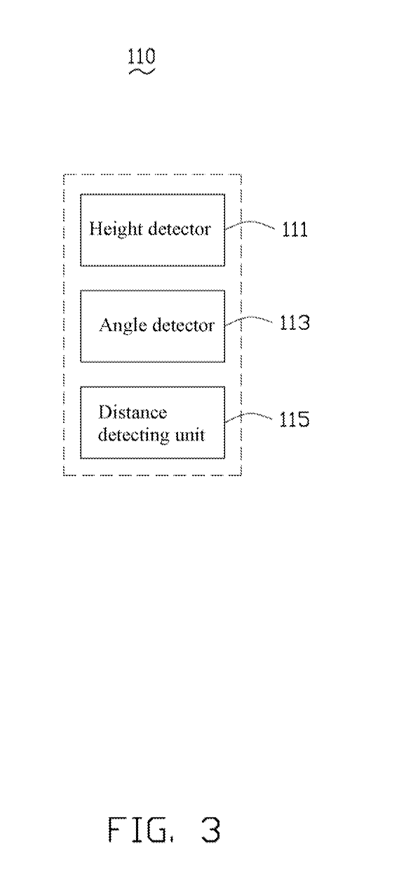

FIG. 3 is a schematic, block diagram of one embodiment of the detecting unit 100 of FIG. 2. The detecting unit 100 includes a height detector 111, an angle detector 113, and a distance detecting unit 115. In one embodiment, the height detector 111 can be a gravity accelerometer, the angle detector 113 can be a gyroscope, and the distance detecting unit 115 can be an infrared detector or a sound wave detector.

The height detector 111 is configured to detect a first horizontal height of the primary display device 10 and transmit the first horizontal height to the processor 130 of the primary display device 10. In one embodiment, the first horizontal height is defined as a distance between a center of the primary display device 10 and a horizontal line (not shown), such as the sea level line.

The angle detector 113 is configured to detect a first slantwise angle of the primary display device 10 and transmit the first slantwise angle to the processor 130 of the primary display device 10. In one embodiment, the first slantwise angle of the primary display device 10 is defined as an included angle between a bottom surface, such as the second side 320, of the primary display device 10 as shown in FIG. 1, and a horizontal plane (not shown), such as the sea level plane.

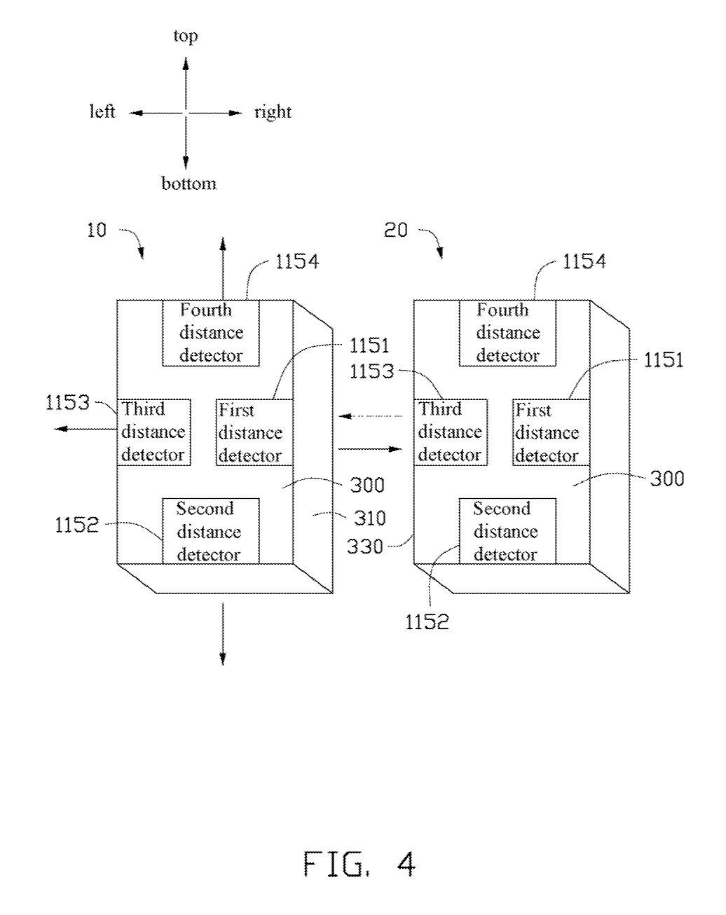

FIG. 4 is a schematic view of the distance detecting unit having four distance detectors arranged at four sides of the primary display device of FIG. 1. The distance detecting unit 115 includes a first distance detector 1151 arranged at a right side of the first display surface 300 of the primary display device 10, a second distance detector 1152 arranged at a bottom side of the first display surface 300 of the primary display device 10, a third distance detector 1153 arranged at a left side of the first display surface 300 of the primary display device 10, and a fourth distance detector arranged at a top side of the first display surface 300 of the primary display device 10 as shown in FIG. 4. In other words, the first to fourth distance detectors 1151-1154 are adjacent to the first to fourth sides 310-340 of the primary display device 10, respectively, in this embodiment.

In this embodiment, each distance detector 1151-1153 includes an infrared emitter and an infrared receiver (not shown). An operation of each distance detector 1151-1153 is the same and a detail operation is described as followings, using the first distance detector 1151 and the third distance detector 1153 for example. The infrared emitter of the first distance detector 1511 of the primary display device 10 is configured to emit infrared light outwards from the first side 310, to an adjacent surface of the secondary display device 20, such as the third side 330 of the secondary display device 20 as shown in FIG. 4. The infrared receiver of the third distance detector 1153 of the secondary display device 20, which faces to the first side 310 of the primary display device 10, receives the infrared light from the infrared emitter of the first distance detector 1151 of the primary display device 10. Thus, the third distance detector 1153 detects a distance between the primary display device 10 and the secondary display device 20 to generate a distance signal according to the received infrared light. The third distance detector 1153 then transmits the distance signal to the processor 130 of the secondary display device 20. The processor 130 of the secondary display device 20 transmits the distance signal to the processor 130 of the primary display device 10 via the transmitting unit 150. In one embodiment, the transmitting unit 150 may be a wireless communicator (not shown). That is, the first distance detector 1151 of the primary display device 10 is configured to detect a secondary display device 20 adjacent to its first side 310 and generates the distance signal to the processor 130 of the primary display device 10.

In alternative embodiment, when more than two secondary display devices 20 are adjacent to the primary display device 10, similar to the first distance detector 1151, the second to fourth detector 1152-1154 of the primary display device 10 may also correspondingly detect other secondary display devices 20 adjacent to its second to fourth sides 320-340 and generates distance signals to the processor 130 of the primary display device 10.

In alternative embodiment, the infrared emitter of the third distance detector 1513 of the secondary display device 20 is configured to emit infrared light outwards to the primary display device 10 when the secondary display devices 20 is adjacent to the primary display device 10 as shown in FIG. 4. The infrared receiver of the first distance detector 1151 of the primary display device 10 receives the infrared light and generates a distance signal according to the received infrared light and directly transmits the distance signal to the processor 130 of the primary display device 10.

The storage unit 150 is configured to store a picture to be displayed and the first horizontal height, the first slantwise angle, and the distance signals.

The transmitting units 150 of the primary display device 10 and the secondary display device 20 are configured to transmit pictures or signals between the primary display device 10 and the secondary display device 20. In this embodiment, the signals transmitted between by the transmitting units 150 can include the first horizontal height, the first slantwise angle, and the distance signals.

The processor 130 of the primary display device 10 is configured to control operations of the height detector 111, the angle detector 113, and the distance detecting unit 115 and receive the first horizontal height, the first slantwise, and the distance signals. In this embodiment, the first height, the first slantwise angle, and the distance signals are defined as a detecting signal. The processor 130 of the primary display device 10 calculates a position relation between the primary display device 10 and the secondary display device 20 according to the first horizontal height, the first slantwise angle, and the distance signals, and divides the picture into a primary part and a secondary part according to the position relation between the primary display device 10 and the secondary display device 20, then transmits the secondary part of the picture to the secondary display device 20.

In this embodiment, the processor 130 controls the display units 190 of the primary display device 10 and the secondary display device 20 to display the primary part of the picture and the secondary part of the picture, respectively.

In alternative embodiment, under the condition that two or more secondary display devices 20 are adjacent to the primary display device 10, the processor 130 of the primary display device 10 calculates position relations between the primary display device 10 and each of the secondary display devices 20 according to the first horizontal heights, the first slantwise angles, and the distance signals of the primary display device 10 and the secondary display devices 20, and divides the picture into a primary part and two or more secondary parts according to the position relations between the primary display device 10 and the secondary display devices 20, then transmits the two or more secondary parts of the picture to the corresponding secondary display devices 20. In this alternative embodiment, the display unit 190 of the primary display device 10 is controlled by the processor 130 to display the primary part of the picture. The two or more secondary display devices 20 are controlled by the processor 130 to display the two or more secondary parts of the picture, correspondingly.

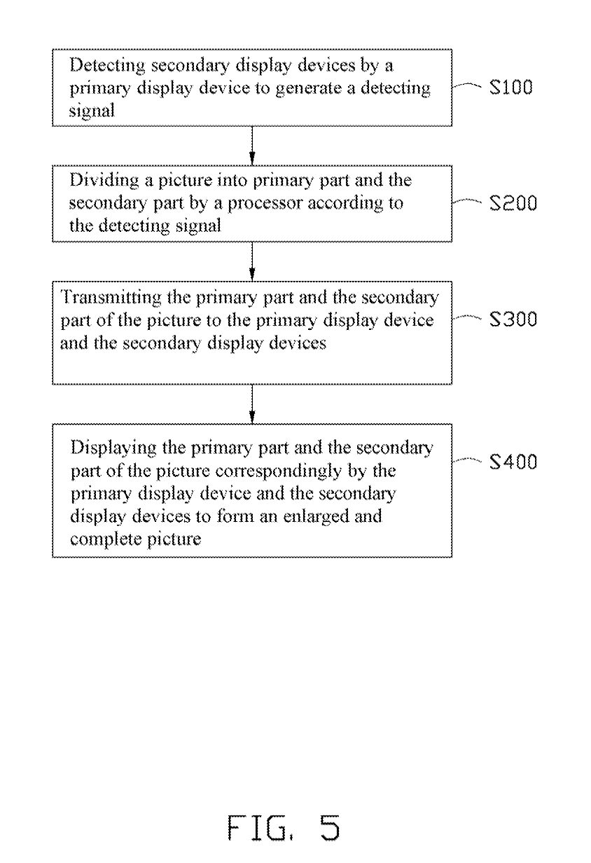

FIG. 5 is a flowchart of a method for dividing and displaying a picture using the display system. The method includes the following steps, but it should be understood that in other embodiments, additional steps may be added, others deleted, and the ordering of the steps may be changed.

In step S100, the primary display device 10 can enter an enlarge-display mode in which the primary display device 10 can employ a secondary display device 20 to work together with an incorporate screen. In the enlarge-display mode, the primary display device 10 detects and finds the at least one secondary display device 20 to confirm both the number of the at least one secondary display device 20 and a position of each secondary display device to generate a detecting signal.

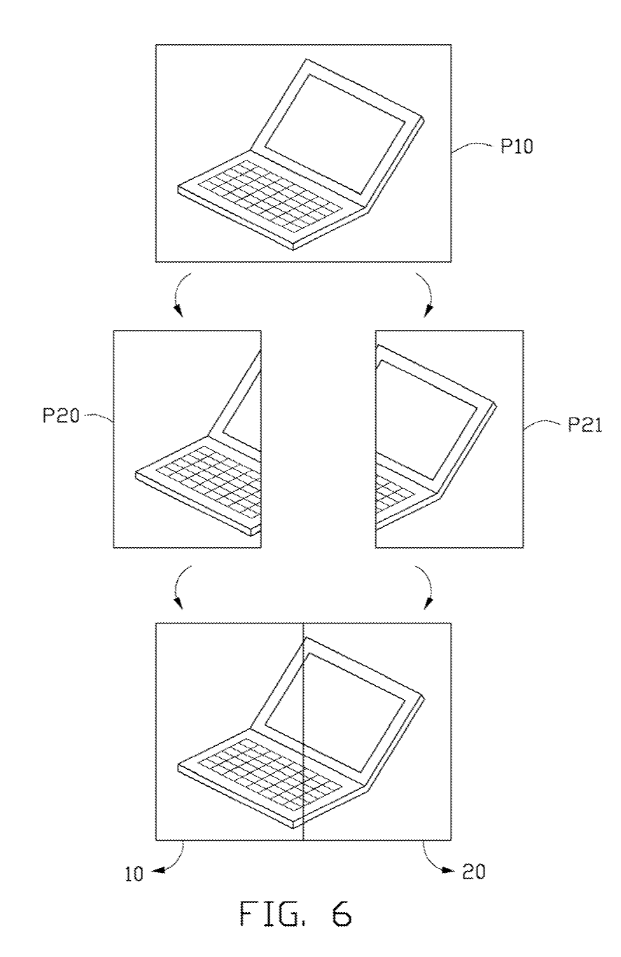

In step S200, in one embodiment, only one secondary display device 20 is adjacent to the primary display device 10 as shown in FIG. 4. The processor 130 of the primary display device 10 divides a picture P10 into a primary part P20 and a secondary part P21 as shown in FIG. 6 according to the detecting signal. The primary part and the secondary part of the picture respectively correspond to the primary display device 10 and the secondary display devices 20. In alternative embodiment, when a plurality of secondary display devices 20 are adjacent to the primary display device 10, the processor 130 of the primary display device 10 divides a picture into a primary part and a plurality of secondary parts according to the detecting signal. The primary part of the picture corresponds to the primary display device 10 and the secondary parts of picture correspond to both the number of the plurality of secondary display devices 20 and the positions of the secondary display device 20.

In step S300, the primary part of the picture is transmitted to the display unit 190 of the primary display device 10. Each secondary part of the picture is correspondingly transmitted to a display unit 190 of a corresponding one of the plurality of secondary display devices 20 by the transmitting units 150 according to the position of each secondary display device 20.

In step S400, the primary part of the picture is controlled by the processor 130 to be displayed on the display unit 190 of the primary display device 10. Each secondary part of the picture is controlled by the processor 130 to be correspondingly displayed on the display unit 190 of one of the plurality of secondary display devices 20 according to the position of each secondary display device 20. Since the picture is divided into the primary part and the secondary parts and respectively displayed by the primary display device 10 and the secondary display devices 20, an enlarged and completed picture can be comfortably observed by a user.

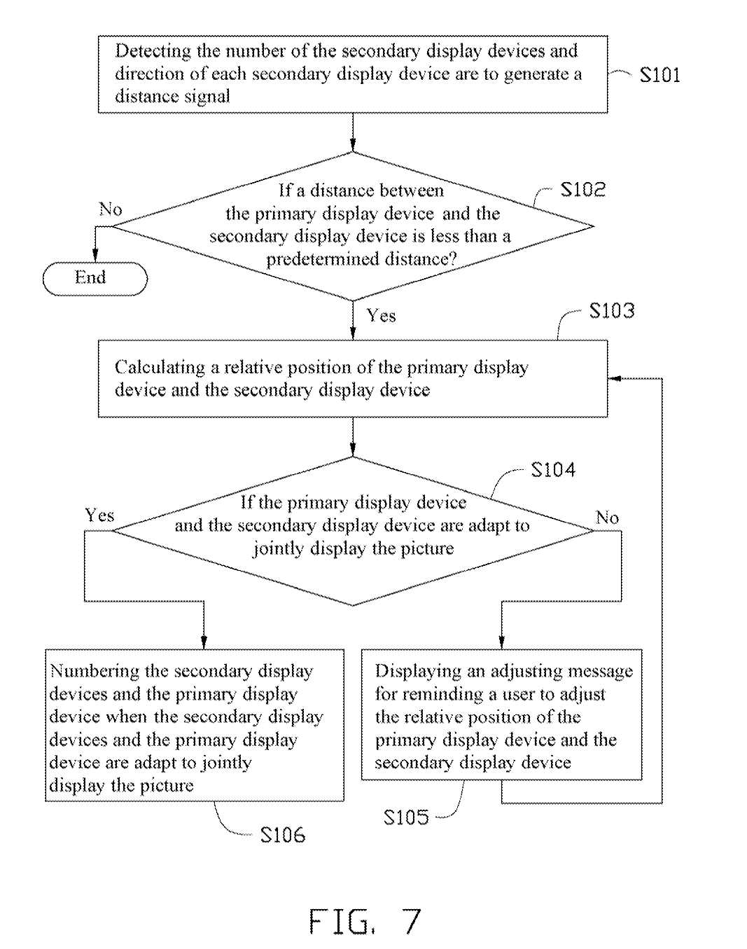

FIG. 7 is a flowchart of a detecting process of the method of FIG. 5 according to one embodiment of the present disclosure. In this embodiment, the detecting process of step 100 is described in detail as followings. The method includes the following steps, but it should be understood that in other embodiments, additional steps may be added, others deleted, and the ordering of the steps may be changed.

In step S101, the number of the secondary display devices and direction of each secondary display device 20 are detected to generate a distance signal. In this step, each of the first to fourth distance detectors 1511-1514 is operated to detect if a secondary display device 20 is adjacent to the primary display device 10 and further confirm if an elongated direction of the secondary display device 20 is parallel to an elongated direction of the primary display device 10.

In one embodiment, when one secondary display device 20 is positioned to be adjacent to the first side 310 of the primary display device 10, the infrared receiver of the first distance detector 1511 of the primary display device 10 receives infrared light from the infrared emitters of the first to fourth distance detectors 1511-1514 of the secondary display device 20, and generates distance signals according to distances from the infrared receiver of the first distance detector 1511 of the primary display device 10 to each infrared emitter of secondary display device 20. The processor 130 of the primary display device 10 determines if the elongated direction of the secondary display device 20 is parallel to the elongated direction of the primary display device 10 according to the distance signals. In this embodiment, when the distances from the second and the fourth distance detectors 1512, 1514 of the secondary display device 20 to the first distance detectors 1511 of the primary display device 10 are substantially equal to each other, the processor 130 of the primary display device 10 determines the elongated direction of the secondary display device 20 is substantially parallel to the elongated direction of the primary display device 10.

In step S102, a distance between the primary display device 10 and the secondary display device 20 is confirmed. When at least one secondary display device 20 is adjacent to the primary display device 10 and has the same elongated direction to the primary display device 10, the processor 130 of the primary display device 10 can further calculate a distance between the primary display device 10 and the secondary display device 20 according to the distance signals. When the distance between the primary display device 10 and the secondary display device 20 is equal to or less than a predetermined distance, step S103 is performed. When the distance between the primary display device 10 and the secondary display device 20 is larger than the predetermined distance, end. In this embodiment, when the distance between the primary display device 10 and the secondary display device 20 is equal to or less than the predetermined distance, the secondary display device 20 is defined to be adjacent to the primary display device 10, the predetermined distance can be set to 10 or 20 millimeters or other distances according to demand and pre-stored in the storage unit 170 of the primary display device 10.

In step S103, a relative position of the primary display device 10 and the secondary display device 20 is calculated. In this step, the height detector 111 of the primary display device 10 detects a first horizontal height of the primary display device 10. The angle detector 113 of the primary display device 10 detects a first slantwise angle of the primary display device 10.

At the same time, the height detector 111 of the secondary display device 20 detects a second horizontal height of the secondary display device 20. The angle detector 113 of the secondary display device 20 detects a second slantwise angle of the secondary display device 20.

In step S104, a process of determining if the primary display device 10 and the secondary display device 20 are adapt to jointly display the picture is performed. The processor 130 of the primary display device 10 receives and compares if the second slantwise angle and the second horizontal height are respectively equal to the first slantwise angle and the first horizontal height. In this step, when a comparing result is yes, the processor 130 considers the primary display device 10 and the secondary display device 20 are coplanar and step 106 is performed. When a comparing result is no, the processor 130 considers the primary display device 10 and the secondary display device 20 are not coplanar and step 105 is performed. In this step, the first slantwise angle, the first horizontal height, the second slantwise signal, and the second horizontal height can also be stored in the storage unit 150 after the processor 130 receives them.

In step S105, an adjusting message for reminding a user to adjust the relative position of the primary display device 10 and the secondary display device 20 is displayed on the display units 190. In step S105, the processor 130 calculates a first difference between the second slantwise signal and the first slantwise angle, a second difference between the second height and the first height. The processor 130 then generates an adjusting message according to the first difference and the second difference so as to help the user adjust the display surface 300 of the secondary display device 20 to be coplanar with the display surface 300 of the primary display device 10. After that, the adjusting message is transmitted to the display units 190 of the primary display device 10 and/or the secondary display device 20 and displayed thereon.

In alternative embodiment, when more than two secondary display devices 20 are positioned adjacent to the primary display device 10, step 102 to step S105 are repeated to similarly confirm a relative position between the primary display device 10 and each secondary display device 20, as described above.

In alternative embodiment, the processor 130 can also generate the adjusting message according to the first difference, the second difference and the distance signals.

In step S106, the secondary display devices 20 adjacent to the primary display device 10 within the predetermined distance are numbered. In one embodiment, when only one secondary display device 20 is adjacent to the first side 310 of the primary display device 10 as shown in FIG. 1, the processor 130 numbers the secondary display device 20 to N111 and the primary display device 10 is numbered as N110.

In an alternative embodiment, when plurality of secondary display devices 20 are respectively adjacent to the primary display device 10, the processor 130 numbers the secondary display devices 20 as Nabc, where “a” is a natural number and represents a total number of the secondary display devices 10, “b” is a natural number and represents a closer side of the first to fourth sides 310-340 of each secondary display devices 20 corresponding to the primary display device 10, “c” is a natural number and represents one side of the first to fourth sides 310-340 of the primary display devices 10 where the closer side 310-340 faces. In this alternative embodiment, the first to fourth sides 310-340 of the primary display devices 10 and the secondary display device 20 are represented by 1 to 4. Supposing four secondary display devices 20 is provided adjacent to the primary display device 10, and when a second side 320 of a secondary display device 20 is adjacent to and closer to the fourth side 340 of the primary display device 10, this secondary display device 20 is numbered as N424.

It is to be understood, however, that even though numerous characteristics and advantages of certain inventive embodiments have been set out in the foregoing description, together with details of the structures and functions of the embodiments, the disclosure is illustrative only; and that changes may be made in detail, especially in matters of arrangement of parts within the principles of present invention to the full extent indicated by the broad general meaning of the terms in which the appended claims are expressed.

What is claimed is:

1. A display system comprising a primary display device and a secondary display device, the display system further comprising:
a first detecting unit configured for detecting if the secondary display device is adjacent to the primary display device, and generating a detecting signal in the condition that the secondary display device is detected to be adjacent to the primary display device;
a storage unit configured for storing a picture; and
a processor configured for receiving the detecting signal and dividing the picture into a primary part and a secondary part according to the detecting signal, the processor further configured for controlling the primary display device to display the primary part of the picture and controlling the secondary display device to display the secondary part of the picture according to the detecting signal.

2. The display system of claim 1, wherein the first detecting unit comprises a first height detector configured to detect a first horizontal height of the primary display device, the first height detector is a gravity accelerometer.

3. The display system of claim 2, wherein the first detecting unit further comprises a first angle detector configured to detect a first slantwise angle of the primary display device, the first angle detector is a gyroscope.

4. The display system of claim 3, wherein the first detecting unit further comprises a first distance detecting unit configured to detect a first distance between the primary display device and the secondary display device, the first distance detecting unit comprising an infrared detector.

5. The display system of claim 4, wherein the secondary display device comprises a second detecting unit, the second detecting unit comprises a second height detector, a second angle detector, and a second distance detecting unit.

6. The display system of claim 5, wherein the second height detector is configured to detect a second horizontal height of the secondary display device, the second height detector is a gravity accelerometer.

7. The display system of claim 6, wherein the second angle detector is configured to detect a second slantwise angle of the secondary display device, the second angle detector is a gyroscope.

8. The display system of claim 7, wherein the second distance detecting unit is configured to generate a second distance between the primary display device and the secondary display device, the second distance detecting unit comprising an infrared detector.

9. The display system of claim 8, wherein the first distance detecting unit comprises a first distance detector adjacent to a first side of the primary display device, a second distance detector adjacent to a second side of the primary display device, a third distance detector adjacent to a third side of the primary display device, and a fourth distance detector adjacent to a fourth side of the primary display device.

10. The display system of claim 9, wherein each one of the first to fourth distance detectors comprises an infrared emitter and an infrared receiver.

11. The display system of claim 10, wherein the storage unit is further configured to store the first horizontal height, the first slantwise angle, and the first and second distances between the primary display device and the secondary display device.

12. The display system of claim 11, wherein the primary display device further comprises a transmitting unit configured to transmit the secondary part of the picture and the detecting signal between the primary display device and the secondary display device.

13. A display system comprising a primary display device and a plurality of secondary display devices, the display system further comprising:
a detecting unit configured for detecting the plurality of secondary display devices to confirm both the number of the plurality of secondary display devices and a position of each of the plurality of secondary display devices to generate a detecting signal;
a storage unit configured for storing a picture; and
a processor configured for receiving the detecting signal and dividing the picture into a primary part and a plurality of secondary parts according to the detecting signal, the processor further configured for controlling the primary display device to display the primary part of the picture and controlling the plurality of secondary displays to display the plurality of secondary parts of the picture according to the number and positions of the plurality of secondary display devices.

14. A method of dividing and displaying a picture using a primary display and at least one secondary display, the method comprising:
generating a detecting signal by the primary display device in an enlarge-display mode;
dividing the picture into a primary part and a secondary part according to the detecting signal by a processor according to the detecting signal;
transmitting the primary part and the secondary part of the picture respectively to the primary display device and the at least one secondary display device; and
displaying the primary part and the secondary part of the picture, respectively by the primary display device and the at least one secondary display device.

15. The method of claim 14, wherein a plurality of secondary display devices are adjacent to the primary display device, the process of generating a detecting signal comprising:
detecting amount of the plurality of secondary display devices and a direction of each of the plurality of secondary display devices;
confirming a distance between the primary display device and each one of the plurality of secondary display devices;
calculating a relative position of the primary display device and each one of the plurality of secondary display devices;
determining if the primary display device and the plurality of secondary display devices are adapt to jointly display the picture;
displaying an adjusting message to adjust the relative position of the primary display device and the plurality of secondary display devices when a determining result is no; and
numbering the plurality of secondary display devices when a determining result is yes.

16. The method of claim 15, further comprising detecting a first horizontal height of the primary display device by a gravity accelerometer.

17. The method of claim 16, further comprising detecting a first slantwise angle of the primary display device by a gyroscope.

18. The method of claim 17, further comprising detecting a first distance between the primary display device and the secondary display devices by an infrared detector.

19. The method of claim 18, further comprising detecting if an elongated direction of each one of the plurality of secondary display devices is parallel to an elongated direction of the primary display device.
